(19) United States
(12) Patent Application Publication
(10) Pub. No.: US 2015/0103164 A1
(43) Pub. Date: Apr. 16, 2015

(54) LIFELOGGING DEVICE, LIFELOGGING SYSTEM AND METHOD OF CONTROLLING A WEARABLE LIFELOGGING DEVICE

(71) Applicant: Narrative AB, Linkoping (SE)

(72) Inventors: Martin Kallstrom, Linkoping (SE); Eric Hampusgard, Linkoping (SE); Linus Pizunski, Lund (SE); Simon Pantzare, Linkoping (SE); Bjorn Wesen, Linkoping (SE)

(21) Appl. No.: 14/513,630

(22) Filed: Oct. 14, 2014

Related U.S. Application Data
(60) Provisional application No. 61/890,558, filed on Oct. 14, 2013.

(51) Int. Cl. H04N 7/18; G01S 3/00; H04N 1/00; H04N 5/225; H04N 5/232

(52) U.S. Cl. CPC H04N 7/185; H04N 5/2252; H04N 5/23203; H04N 5/23216; H04N 1/00244; H04N 5/23241; H04N 1/00114; G01S 3/00
USPC 348/143

(57) ABSTRACT

A wearable lifelogging device for generating and associating image data, time data and location data. The device comprises a positioning sensor for receiving a geographic position signal and generating the location data, a motion sensor for generating motion data, a timer for generating the time data, a camera device for generating the image data, a storage device for storing the image data, time and location data, a processing device configured to receive and process the location data, the motion data, the time data and the image data, and a housing enclosing said positioning sensor, motion sensor, timer, camera device, storage device and processing device. The housing, except for the camera, is free from user input interface.

### CROSS-REFERENCE TO RELATED APPLICATION

This application claims the benefit of U.S. Patent Application No. 61/890,558, filed Oct. 14, 2013, the entire contents of which are incorporated herein by reference.

### FIELD

The present disclosure relates to a method for lifelogging and to a system which implements such a method.

### BACKGROUND

Lifelogging is the process of digitally lifelogging life experiences. A lifelogging system usually comprises a wearable lifelogging device which automatically and continuously captures the user's activities in the form of text and/or sensor data, such as image, audio or video lifeloggings which are stored and organized for future use.

People may want to log their activities for their own enjoyment, for example for keeping a diary or being able to retrieve and share personal experiences, including unanticipated ones, with others. Lifelogging may also be used for medical purposes, for example as an aid for people suffering from memory impairment.

Another application for lifelogging devices is one of personal security; a lifelogging device may be used to provide evidence in the event the user is harassed or attacked.

Yet another application is one of quality assurance; a lifelogging device may be used to document the user's activity. For example a police officer, nurse, physician, fireman, corrections officer, keeper or caretaker may use a lifelogging device to provide documentation of work performed and/or as evidence against accusations of malpractice or abuse.

For a lifelog not to be inconvenient and cumbersome to produce, it is important that the lifelogging system be user friendly and interfere as little as possible with the user's daily routine. It is desirable to improve existing lifelogging systems in these respects.

### SUMMARY

Some embodiments disclosed herein may improve the user experience of lifelogging systems. Some embodiments may provide a lifelogging system which is easy, efficient and satisfying to use. Embodiments are set forth in the description and drawings.

According to a first aspect, there is provided a wearable lifelogging device for generating and associating image data, time data and location data. The device comprises a positioning sensor for receiving a geographic position signal and generating the location data, a motion sensor for generating motion data, a timer for generating the time data, a camera device for generating the image data, a storage device for storing the image data, time and location data, a processing device configured to receive and process the location data, the motion data, the time data and the image data, and a housing enclosing said positioning sensor, motion sensor, timer, camera device, storage device and processing device, wherein the housing, except for the camera, is free from user input interface.

The term “user input interface” is defined as a device for detecting a relative motion between a user, e.g. the user's hand or finger, and the housing. Such devices include buttons, knobs, wheels, switches, touch sensors and the like.

The “location data” may be data which directly or indirectly identifies a geographic position, such as “clear text” position coordinates or raw data, e.g. data related to a satellite signal, which needs to be processed in order for position information to be derived.

The fact that the device has no user input interface adds to the user's experience of the device “not being there”, i.e. while the device is being worn, there will be nothing the user can do to interact with it, and thus there will be nothing that attracts the user's attention to it, e.g. in the sense that there are no buttons inviting the user to fidget or even providing a possibility of interaction. All of this adds to keeping the device's interference with the user's daily habits to a minimum. Likewise, to a third party, the mere presence of the device will lead to the conclusion that it is active, since there is no way of manipulating it when it is being worn.

The housing may present at least one opening, selected from a group consisting of a camera opening, an indicator opening, a communication port and an attachment recess for allowing the device to be worn by a user.

The indicator may be e.g. one or more LEDs, a display, etc.

The device may further comprise an attachment device in the form of a clip, a pin, a noose, a through hole, etc.

The processing device may be configured to autonomously capture said image data, said time data and said location data. For example the device may take photos at a regular time interval, which may be predetermined, at a random interval (possibly with a variable likelihood that can be adjusted) and/or on receipt of specific sensor data, such as sound, movement, light, etc.

According to a second aspect, there is provided a method of controlling a wearable lifelogging device, comprising the steps of: providing a wearable lifelogging device comprising a camera unit, a motion sensor and a processing device; receiving an image signal from the camera unit; receiving a sensor signal from the motion sensor; processing the image signal to determine whether it, during a first predetermined time period, represents an amount of light exceeding a predetermined light level; processing the sensor signal to determine whether it, during a second predetermined time period, represents an amount of motion exceeding a predetermined motion level; and causing the camera unit to generate another image signal only if the amount of light exceeds the predetermined light level and the motion level exceeds the predetermined motion level.

A lifelogging device is defined as a wearable device which is configured for continuous or intermittent capture of images of the user and/or the user's experiences. Images thus captured may be associated with data indicating time/date and/or geographic position information for the respective image. The lifelogging device may be configured with an integrated intermediate image and data storage device. In the alternative, the lifelogging device may be configured for online transmission of image and data to a network-accessible storage device.

Hence, the lifelogging device is active unless it has not moved appreciably for a certain amount of time or the surroundings are darker than a certain level. The lifelogging device will therefore not produce large numbers of completely dark or identical photographs. Moreover, using the wearable lifelogging device becomes extremely easy and requires minimal effort. For example, a user only has to start wearing the lifelogging device to activate it and to put it in a pocket or on a table to deactivate it. The motion sensor may generate orientation and/or position data which is associated with each photograph so that the photographs are displayed with the correct orientation regardless of the orientation of the camera when the photograph is taken.

The method may further comprise processing the sensor signal to determine whether it, during a third predetermined time period, corresponds to a predetermined gesture.

The user may thereby easily trigger the camera to take a photograph at a particular moment by, for example, tapping the camera twice, or any other number of times.

The method may further comprise connecting the lifelogging device to a network, and receiving lifelogging device control data via the network while the lifelogging device is connected to the network, wherein the lifelogging device control data comprises image capture frequency control data.

According to a third aspect, there is provided a lifelogging system comprising a wearable lifelogging device for generating and associating image data, time data and location data. The wearable lifelogging device comprises a housing substantially enclosing: a positioning system for receiving a geographic position signal and generating the location data; a motion sensor for generating motion data; a timer for generating the time data; a camera device for generating the image data; a storage device for storing the image data, time and location data; a processing device configured to receive and process the location data, the motion data, the time data and the image data; a communication interface for transmitting the location data, the time data and the image data, and for receiving lifelogging device control data; a user interface for receiving a signal indicating user input for controlling the lifelogging unit; a network-based storage device configured for storing, organizing and analyzing the location data, time data and image data generated by the lifelogging unit; and a communication device, connectable to the communication interface for receiving the location data, the time data and the image data from the lifelogging device, for transmitting the location data, the time data and the image data to the network-based storage device, and for transmitting the control data to the lifelogging device. The user interface is configured such that, when the communication device is not connected to the communication interface, the signal indicating user input is based on data selected from a group consisting of the motion data and the image data.

A network-based storage device is defined as a storage device which is accessible via a network. The storage device may be provided as a physical device which is owned by the user or an organization associated with the user. In the alternative, the storage device may be provided as a storage service which is accessible via the network.

Since the wearable lifelogging device receives control data from the communication device, it may lack buttons, knobs, switches or similar means for controlling the device. A design having a reduced number of components may result in a simpler and more economical production process. Such a design can also make the wearable lifelogging device very user friendly since the wearable lifelogging device requires no user input during use. Once the control parameters are set using the communication device, all the user is required to do in order to start lifelogging is to wear the wearable lifelogging device. Ease of use and minimal interference with the user's activities are essential features for a device which is supposed to be worn regularly. Such features are also likely to make the wearable recording unit more attractive to people who are interested in lifelogging but uninterested in electronic gadgets.

Still, despite lacking buttons, the wearable lifelogging device is highly configurable via the communication device with which a user may set control parameters for the wearable lifelogging device. The communication device may also be used to set control parameters for the network-based storage device.

The processing device may be configured to associate the image data with respective time data and location data.

Hence, the images may be analyzed and organized based on time and location as well as image characteristics.

The communication device may comprise: a lifelogging device interface adapted for communication with the communication interface of the lifelogging device, and a network interface adapted for communication with the network-based storage device.

The communication device may be provided as a separate unit, which is connectable to the lifelogging device via the lifelogging device interface and to the network-based storage device via the network interface and a network.

The lifelogging device interface may comprise a connection selected from a group consisting of an electric connection, an optical connection, a radio frequency based connection and an inductive connection.

The network interface may comprise a connection selected from a group consisting of a cellular network connection, a wireless LAN connection and a wired LAN connection.

The communication device may comprise a power supply module for supplying battery charging power to the lifelogging unit.

The power supply module may comprise a power connection selected from a group consisting of an electric connection and an inductive connection.

The lifelogging system may further comprise a user terminal, comprising a processing device, a presentation device, a user input device and a communication unit for receiving the image data and for transmitting user control data.

The communication device may be integrated with the user terminal, and wherein the communication unit of the user terminal is configured to receive the image data from the lifelogging unit and optionally to transmit the image data to the network-based storage device.

The communication unit of the user terminal may be configured to receive the image data from the network-based storage device.

The lifelogging system may further comprise an image data processing service, which is configured to: receive the user control data from the user terminal, process the user control data to derive image control data, receive the image data from the network-based storage device, and process the image data in accordance with the image control data.

The lifelogging system may further comprise a lifelogging device control service, which is configured to: receive the user control data from the user terminal, process the user control data to derive lifelogging device control data, and transmit the lifelogging device control data to the lifelogging device when the lifelogging device is connected to the network-based storage device.

According to a fourth aspect, there is provided a wearable lifelogging device for generating and associating image data, time data and location data. The device comprises a positioning sensor for receiving a geographic position signal and generating the location data, a motion sensor for generating motion data, a timer for generating the time data, a camera device for generating the image data, a storage device for storing the image data, time and location data, a processing device configured to receive and process the location data, the motion data, the time data and the image data, a housing enclosing said positioning sensor, motion sensor, timer, camera device, storage device and processing device, the housing presenting at least one major surface and side surfaces extending from edges of the major surface, and an attachment device in the form of a clip, which extends beyond one of the side surfaces, as seen in a direction parallel with the main surface.

The main surface may be a front or rear surface of the lifelogging device.

### BRIEF DESCRIPTION OF THE DRAWINGS

For a more complete understanding of embodiments of a lifelogging device, system, and associated methods, reference should now be had to the embodiments shown in the accompanying drawings and described below. In the drawings:

FIG. 1 is a schematic illustration of components of a lifelogging system.

FIGS. 2a-2c are schematic illustrations of different configurations of a lifelogging system.

FIG. 3 is a front view of an embodiment of lifelogging device.

FIGS. 4a-4c are side views illustrating different embodiments of the lifelogging device of FIG. 3.

### DETAILED DESCRIPTION

The following detailed description of embodiments refers to the accompanying drawings, which illustrate specific embodiments. Other embodiments having different structures and operation do not depart from the scope of the present disclosure.

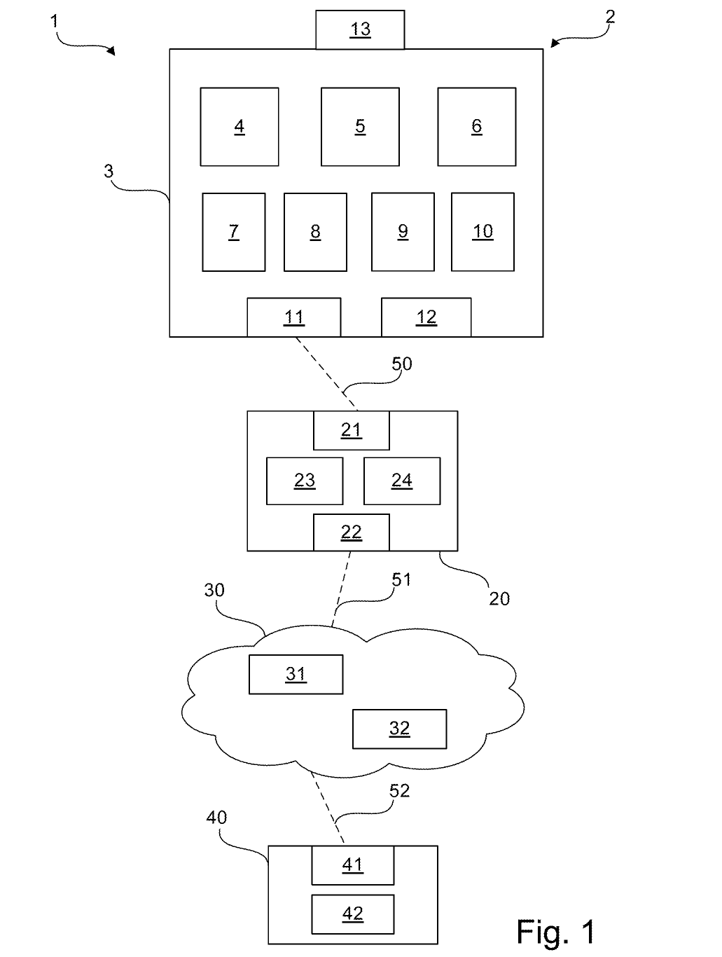

Referring to the drawings, where like reference numerals refer to the same or similar parts, FIG. 1 illustrates schematically components of a lifelogging system 1. The system 1 comprises a wearable lifelogging device 2 which has a weather protected housing 3 which encloses a GPS unit 4, an accelerometer 5, a timer 6 (which may have the form of a real-time clock (RTC)), a camera 7, a storage device 8 which may comprise volatile and non-volatile memory, a CPU 9, a rechargeable battery 10, a communication interface 11 and a user interface 12. A clip 13 is arranged on the outside of the housing. The system 1 also comprises a first communication device 20 which has interfaces 21 and 22 for communicating with the lifelogging device 2 and a network-based storage service 30, respectively. The first communication device 20 can have a controller 23 and a charger 24. The network-based storage service 30 may comprise a storage service 31 and a computing service 32. The network-based storage service 30 may also be connected to a second communication device 40 via the latter's interface 41. The second communication device 40 also comprises application software 42.

Dashed lines represent connections 50, 51 and 52 between the components of the lifelogging system 1.

When a user wears the lifelogging device 2, for example by attaching it to a piece of clothing or a necklace, the camera 7 may be preset to automatically take two photographs a minute. It is also possible to allow the user to trigger the camera to take a photograph by performing a predetermined gesture, such as tapping the camera once, twice or three times within a predetermined time period and possibly in a predetermined direction.

The CPU 9 may be programmed to stop taking photographs, power off and/or cause the camera 7 to hibernate or go into a low-power mode (e.g. by turning off one or more other sensors), if it receives a predetermined sensor signal from the camera indicating that the photograph is darker than a predetermined level.

The CPU 9 may also be programmed to stop taking photographs, power off and/or cause the camera 7 to hibernate or go into a low-power mode (e.g. by turning off one or more other sensors), if it receives a sensor signal from the accelerometer 5 indicating that the lifelogging device 2 has moved less than a predetermined amount during a predetermined amount of time.

With each photograph, the CPU 9 may associate location data from the GPS unit 4, orientation data from the accelerometer 5 and time (optionally including date) data from the timer 6. The image, location, orientation and time data of the photograph are stored in non-volatile memory on the storage device 8 and transferred via the first communication device 20 to the storage service 31 of the network-based storage service 30 when a connection 50 is established between the lifelogging device 2 and the first communication device 20. The transfer may occur during charging of the battery 10 by the charger 24 and the storage may be encrypted.

The first communication device 20 may be a docking station, a smartphone, a tablet computer, a desktop computer or a laptop computer.

The connection 50, which connects the lifelogging device 2 to the first communication device 20 via the interfaces 11 and 21, may be a wired connection, such as a micro-USB or USB connection, or a wireless connection, such as a wireless LAN, Bluetooth®, NFC, IR, CDMA, GSM, 3G or 4G connection.

The protocol used for communication between the lifelogging device 2 and the first communication device 20 may be the USB mass storage device protocol or a device-specific protocol. A device-specific protocol may comprise features making communication possible only between a specific lifelogging device 2 and a specific communication device 20, which would make it more difficult for an unauthorized person to retrieve the data stored on the lifelogging device 2.

The connection 51, which connects the first communication device 20 to the network-based storage service 30 via the interface 22, may be a wired connection, such as a wired LAN connection, or a wireless connection, such as wireless LAN, CDMA, GSM, 3G or 4G connection.

The protocol used for communication between the first communication device 20 and the network-based storage service 30 may be TCP/IP, HTTP, HTTPS, SSL and TLS.

The network-based storage service 30 may be a REST service.

The computing service 32 of the network-based storage service 30 may analyze and organize the photographs based on its image, location, orientation and/or time data. The photographs may be organized on a timeline and into groups of photographs fulfilling certain criteria, such as being from the same surroundings. The criteria may be user defined and the colors of the images may be used to determine which photographs were taken in the same surroundings. The photographs may be analyzed and their relevance assessed using criteria based on, for example, motion blur, contrast, composition, light, face recognition and object recognition. A group of photographs fulfilling certain criteria may be analyzed in order to select a photograph which is particularly representative, according to some criteria, of that group of photographs. The selected photograph may be used to give the user a rough idea of what the photographs in the group of photographs are showing and when they were taken.

The user can use a second communication device 40, for example a smartphone, a tablet computer, a desktop computer or a laptop computer, to access the photographs and to set control parameters for the lifelogging device 2, the network-based storage service 30 and the first communication device 20.

Control parameters may, for example, determine the image capture rate and the time dependence of the image capture rate. For example, a user may set a higher image capture rate during a certain time period of a certain day. Control parameters may also determine whether a photograph stored on storage device 31 can be accessed by other users.

The user may use the second communication device 40 to perform computing functions of the computing service 32. A computing function may be photo editing.

The application software 42, which, for example, can be a web browser or an application for smartphones or tablet computers, may be used to perform the computing functions and to set control parameters.

The connection 52, which connects the second communication device 40 to the network-based storage service 30 via the interface 41, may be a wired connection, such as a wired LAN connection, or a wireless connection, such as a wireless LAN, CDMA, GSM, 3G or 4G connection.

The protocol used for communication between the second communication device 40 and the network-based storage service 30 may be TCP/IP, HTTP, HTTPS, SSL and TLS.

The network-based storage service 30 may send push notifications to the second communication device 40, for example when photographs taken by the lifelogging device 2 have been transferred to the network-based storage service 30.

The network-based storage service 30 may send data to and receive data from devices which are not a part of the lifelogging system 2. For example, data captured by the GPS unit 4 may be sent to a third-party which analyses the data and sends the coordinates represented by the data to the network-based storage service 30. The network-based storage service 30 may send and receive data, for example image data, to other network-based services, for example social-networking services.

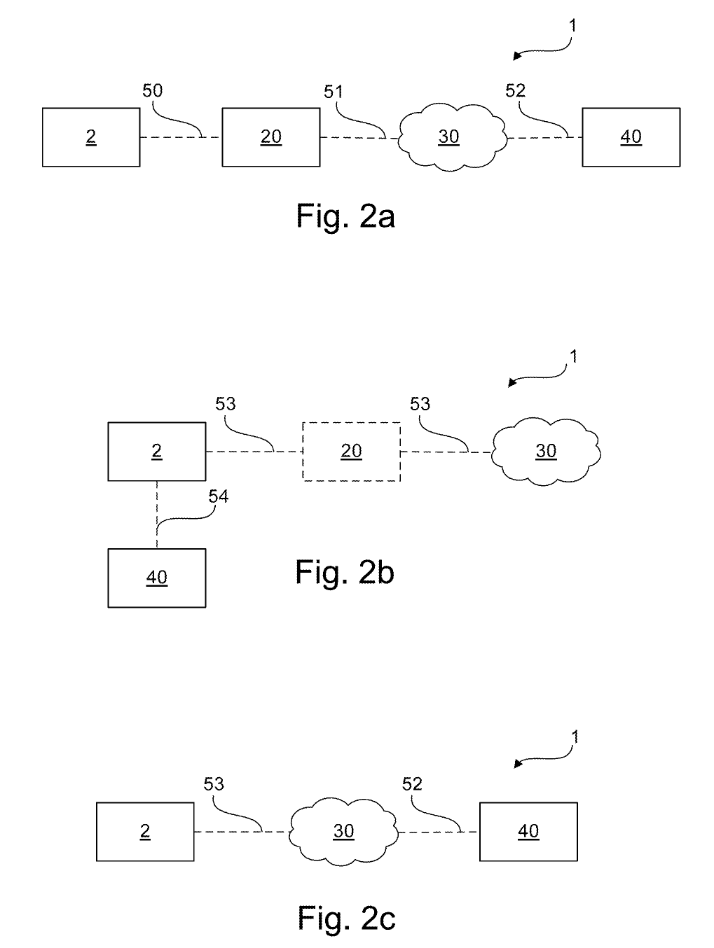

FIG. 2a illustrates schematically a lifelogging system 1 in which the lifelogging device 2 is configured to send image, location, orientation and time data to a first communication device 20 over a connection 50 which may be a wired connection, such as a micro-USB, USB or wired LAN connection, or a wireless connection, such as a wireless LAN, bluetooth, NFC, IR, CDMA, GSM, 3G or 4G connection. The protocol used for communicating over the connection 50 may be the USB mass storage device protocol, TCP/IP, HTTP, HTTPS, SSL or TSL or a device-specific protocol.

The first communication device 20 may be a docking station, a smartphone, a tablet computer, a desktop computer or a laptop computer.

The first communication device 20 is configured to send the image, location, orientation and time data to the network-based storage service 30 over a connection 51 which may be a wired connection, such as a wired LAN connection, or a wireless connection, such as wireless LAN, CDMA, GSM, 3G or 4G connection. The protocol used for communicating over the connection 51 may be TCP/IP, HTTP, HTTPS, SSL or TSL.

A user can access the data stored on the network-based storage service 30 through a second communication device 40 which is also configured to send control parameters to the network-based storage service 30 over a connection 52. The connection 52 may be a wired connection, such as a wired LAN connection, or a wireless connection, such as a wireless LAN, CDMA, GSM, 3G or 4G connection. The protocol used for communicating over the connection 52 may be TCP/IP, HTTP, HTTPS, SSL or TSL.

The control parameters sent by the second communication device 40 may comprise control parameters for the network-based storage service 30, the first communication device 20 and the wearable lifelogging device 2. The network-based storage service 30 transfers, over the connection 51, control parameters to the first communication device 20 which, in turn, transfers the control parameters to the wearable lifelogging device 2 over the connection 50.

FIG. 2b illustrates schematically a lifelogging system 1 in which a wearable lifelogging device 2 is configured to communicate directly with a second communication device 40 and a network-based storage service 30 over connections 53 and 54, respectively.

The second communication device 40 may be a smartphone, a tablet computer, a desktop computer or a laptop computer.

The connection 53 may be a wired connection, such as a wired LAN connection, or a wireless connection, such as a wireless LAN, CDMA, GSM, 3G or 4G connection. The protocol used for communicating over the connection 53 may be TCP/IP, HTTP, HTTPS, SSL or TSL.

The connection 54 which may be a wired connection, such as a micro-USB, USB or wired LAN connection, or a wireless connection, such as a wireless LAN, bluetooth, NFC, IR, CDMA, GSM, 3G or 4G connection. The protocol used for communicating over the connection 54 may be the USB mass storage device protocol, TCP/IP, HTTP, HTTPS, SSL or TSL or a device-specific protocol.

If a first communication device 20 is provided, the lifelogging device 2 may also communicate with the first communication device 20 which may be configured to communicate with the network-based storage service 30.

The first communication device 20 may be a docking station, a smartphone, a tablet computer, a desktop computer or a laptop computer.

The first communication device 20 may communicate with the be lifelogging device 2 over a wired connection, such as a micro-USB, USB or wired LAN connection, or a wireless connection, such as a wireless LAN, bluetooth, NFC, IR, CDMA, GSM, 3G or 4G connection. The protocol used for communicating may be the USB mass storage device protocol, TCP/IP, HTTP, HTTPS, SSL or TSL or a device-specific protocol.

The first communication device 20 may communicate with the network-based storage service 30 over a wired connection, such as a wired LAN connection, or a wireless connection, such as a wireless LAN, CDMA, GSM, 3G or 4G connection. The protocol used for communicating may be TCP/IP, HTTP, HTTPS, SSL or TSL.

FIG. 2c illustrates schematically a lifelogging system 1 in which a wearable lifelogging device 2 and a network-based storage service 30 are configured to communicate over a connection 53 which may be a wired connection, such as a wired LAN connection, or a wireless connection, such as a wireless LAN, CDMA, GSM, 3G or 4G connection. The protocol used for communicating over the connection 53 may be TCP/IP, HTTP, HTTPS, SSL or TSL.

Communication also occurs between the network-based storage device 30 and a communication device 40 over a connection 52 which may be a wired connection, such as a wired LAN connection, or a wireless connection, such as a wireless LAN, CDMA, GSM, 3G or 4G connection. The protocol used for communicating over the connection 52 may be TCP/IP, HTTP, HTTPS, SSL or TSL.

The communication device 40 may be a smartphone, a tablet computer, a desktop computer or a laptop computer.

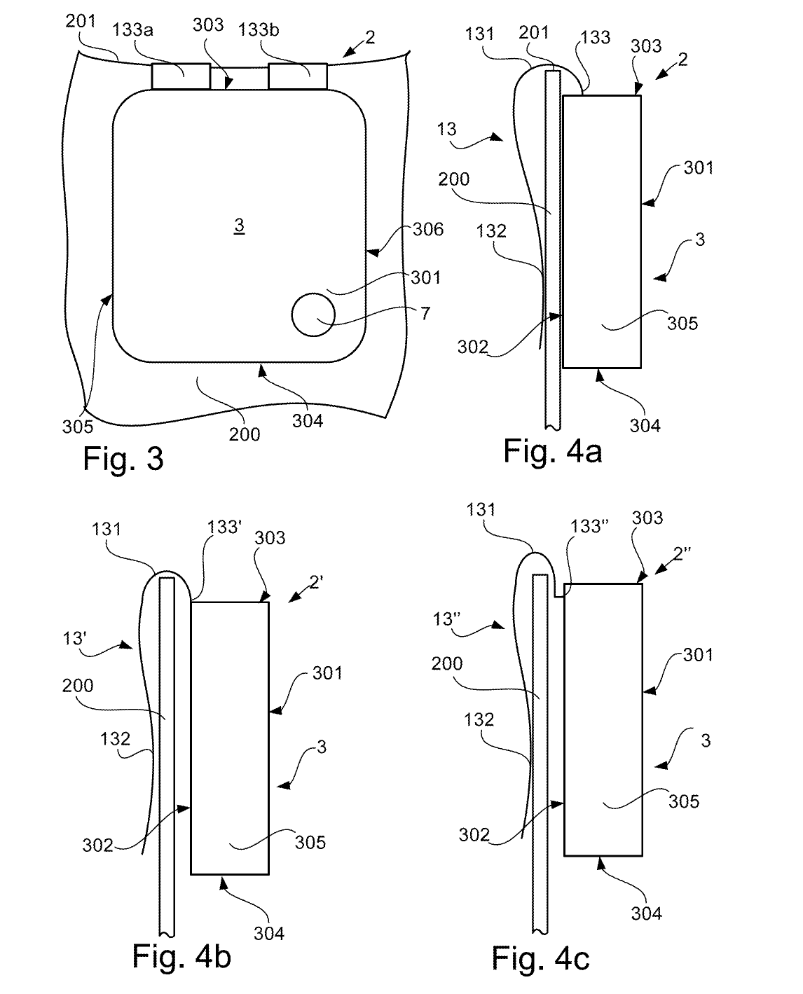

FIG. 3 schematically illustrates a front view of a lifelogging device 2, which is attached by means of a clip to a front portion of a collar 201 of a piece of clothing 200, such as a t-shirt, sweater, cardigan, jacket, shirt, coat, blouse or the like.

The lifelogging device 2 has a housing 3 which presents a pair of opposing main surfaces 301, 302, one of which constituting a front surface 301 and the other one constituting a rear surface 302. The main surfaces are generally rectangular (although with rounded corners) and presents an upper side surface 303, a lower side surface 304 and left and right side surfaces 305, 306. At the front surface, 301, there is an opening for the camera 7 as described above.

The lifelogging device 2 further comprises a clip 13, 13′, 13″, by which the attachment to the piece of clothing 200 is effected. The clip comprises an attachment portion 133, 133′, 133″, a clamping portion 132 and an intermediate portion 131.

The attachment portion 133, 133′, 133″connects the clip with the housing 3. The clamping portion 132 is designed to clamp the piece of clothing 200 against the rear surface 302 of the housing 3. Hence, the clamping portion 132 may be biased towards the housing 3.

The rear surface 302 of the housing 3 may present at least a portion having higher coefficient of friction than the front surface 301 and/or than the side surfaces 305, 306. For example, the entire rear surface 302 may be formed of rubber or rubber-like material, such as TPU, TPE or the like. As another option, the rear surface may be provided with dots, protrusions or dimples of such rubber or rubber-like material.

The clip may present a portion 131, 131a, 131b, which protrudes beyond the at least one of the side surfaces 303, 304, 305, 306, as seen in a direction parallel with the front and/or rear surface 301, 302.

As illustrated in FIG. 4a, the attachment portion 133 of the clip 13 may be connected to a side surface 303 of the housing 3, with the connection being spaced from all edges of this side surface 303. The attachment portion may be closer to one of the edges of the side surface 303 than the other edges, and the attachment portion may extend substantially parallel with this edge.

As illustrated in FIG. 4b, the attachment portion 133′ of the clip 13′ may be connected to a side surface 303 of the housing 3, with the connection being adjacent or on one of the edges of this side surface 303, such as one of the long side edges of the side surface 303.

As illustrated in FIG. 4c, the attachment portion 133″ of the clip 13″ may be connected to the rear surface 302 of the housing 3, with the connection being spaced from all edges of this rear surface 302. The attachment portion may be closer to one of the edges of the rear surface 302 than the other edges, and the attachment portion may extend substantially parallel with this edge.

The portion 131 protruding beyond the side surface may protrude by at least 5%, preferably 10%, 15% or 20% of a length of the housing 3 as seen in a direction parallel with the extension of the clip 13, 13′, 13″.

The protruding portion 131 may form a bend through about 180°.

The clip may be formed of a metallic material or a plastic material having sufficient strength and elasticity to operate as a clip in a range of temperatures in which the lifelogging device 2 is intended to be operable.

The clip may be formed as a single clip or as two or more pieces which are separate and/or connected to each other. For example, the clip may present two attachment portions 133a, 133b, which connect to each other at a free end of the clip 13, 13′, 13″.

Although specific embodiments have been illustrated and described herein, those of ordinary skill in the art appreciate that any arrangement which is calculated to achieve the same purpose may be substituted for the specific embodiments shown and that the embodiments herein have other applications in other environments. This application is intended to cover any adaptations or variations of the present disclosure. The following claims are in no way intended to limit the scope of the disclosure to the specific embodiments described herein.

What is claimed is:

1. A wearable lifelogging device for generating and associating image data, time data and location data, the device comprising:
a positioning sensor for receiving a geographic position signal and generating the location data;
a motion sensor for generating motion data;
a timer for generating the time data;
a camera device for generating the image data;
a storage device for storing the image data, time and location data;
a processing device configured to receive and process the location data, the motion data, the time data and the image data; and
a housing enclosing said positioning sensor, motion sensor, timer, camera device, storage device and processing device,
wherein the housing, except for the camera, is free from user input interface.

2. The device as claimed in claim 1, wherein the housing presents at least one opening, selected from a group consisting of a camera opening, an indicator opening, a communication port and an attachment recess for allowing the device to be worn by a user.

3. The device as claimed in claim 1, further comprising an attachment device in the form of a clip, a pin, a noose, or a through hole.

4. The device as claimed in claim 1, wherein the processing device is configured to autonomously capture said image data, said time data and said location data.

5. A method of controlling a wearable lifelogging device, comprising:
providing a wearable lifelogging device comprising a camera unit, a motion sensor and a processing device;
receiving an image signal from the camera unit;
receiving a sensor signal from the motion sensor;
processing the image signal to determine whether it, during a first predetermined time period, represents an amount of light exceeding a predetermined light level;
processing the sensor signal to determine whether it, during a second predetermined time period, represents an amount of motion exceeding a predetermined motion level; and
causing the camera unit to generate another image signal only if the amount of light exceeds the predetermined light level and the motion level exceeds the predetermined motion level.

6. The method as claimed in claim 5, further comprising processing the sensor signal to determine whether it, during a third predetermined time period, corresponds to a predetermined gesture.

7. The method as claimed in claim 5, further comprising:
connecting the lifelogging device to a network; and
receiving lifelogging device control data via the network while the lifelogging device is connected to the network,
wherein the lifelogging device control data comprises image capture frequency control data.

8. A lifelogging system comprising:
a wearable lifelogging device for generating and associating image data, time data and location data, comprising a housing substantially enclosing:
a positioning system for receiving a geographic position signal and generating the location data;
a motion sensor for generating motion data;
a timer for generating the time data;
a camera device for generating the image data;
a storage device for storing the image data, time and location data;
a processing device configured to receive and process the location data, the motion data, the time data and the image data;
a communication interface for transmitting the location data, the time data and the image data, and for receiving lifelogging device control data;
a user interface for receiving a signal indicating user input for controlling the lifelogging unit;
a network-based storage device configured for storing, organizing and analyzing the location data, time data and image data generated by the lifelogging unit; and
a communication device, connectable to the communication interface for receiving the location data, the time data and the image data from the lifelogging device, for transmitting the location data, the time data and the image data to the network-based storage device, and for transmitting the control data to the lifelogging device;
wherein the user interface is configured such that, when the communication device is not connected to the communication interface, the signal indicating user input is based on data selected from a group consisting of the motion data and the image data.

9. The system as claimed in claim 8, wherein the processing device is configured to associate the image data with respective time data and location data.

10. The system as claimed in claim 8, wherein the communication device comprises:
a lifelogging device interface adapted for communication with the communication interface of the lifelogging device; and
a network interface adapted for communication with the network-based storage device.

11. The system as claimed in claim 10, wherein the communication device is provided as a separate unit, which is connectable to the lifelogging device via the lifelogging device interface and to the network-based storage device via the network interface and a network.

12. The system as claimed in claim 10, wherein the lifelogging device interface comprises a connection selected from a group consisting of an electric connection, an optical connection, a radio frequency based connection and an inductive connection.

13. The device as claimed in claim 10, wherein the network interface comprises a connection selected from a group consisting of a cellular network connection, a wireless LAN connection and a wired LAN connection.

14. The system as claimed in claim 8, wherein the communication device comprises a power supply module for supplying battery charging power to the lifelogging unit.

15. The system as claimed in claim 14, wherein the power supply module comprises a power connection selected from a group consisting of an electric connection and an inductive connection.

16. The system as claimed in claim 8 further comprising a user terminal, comprising a processing device, a presentation device, a user input device and a communication unit for receiving the image data and for transmitting user control data.

17. The system as claimed in claim 16, wherein the communication device is integrated with the user terminal, and wherein the communication unit of the user terminal is configured to receive the image data from the lifelogging unit and optionally to transmit the image data to the network-based storage device.

18. The system as claimed in claim 16, wherein the communication unit of the user terminal is configured to receive the image data from the network-based storage device.

19. The system as claimed in claim 18, further comprising an image data processing service, which is configured to:
receive the user control data from the user terminal;
process the user control data to derive image control data;
receive the image data from the network-based storage device; and
process the image data in accordance with the image control data.

20. The system as claimed in claim 19, further comprising a lifelogging device control service, which is configured to:
receive the user control data from the user terminal;
process the user control data to derive lifelogging device control data; and
transmit the lifelogging device control data to the lifelogging device when the lifelogging device is connected to the network-based storage device.

21. A wearable lifelogging device for generating and associating image data, time data and location data, the device comprising:
a positioning sensor for receiving a geographic position signal and generating the location data;
a motion sensor for generating motion data;
a timer for generating the time data;
a camera device for generating the image data;
a storage device for storing the image data, time and location data;
a processing device configured to receive and process the location data, the motion data, the time data and the image data;
a housing enclosing said positioning sensor, motion sensor, timer, camera device, storage device and processing device;
the housing presenting at least one major surface and side surfaces extending from edges of the major surface; and
an attachment device in the form of a clip, which extends beyond one of the side surfaces, as seen in a direction parallel with the main surface.
